(19) United States
(12) Patent Application Publication
(10) Pub. No.: US 2026/0348227 A1
(43) Pub. Date: Nov. 5, 2026

(54) PIVOT-LIMITING MECHANISM FOR A SLIDING PIVOTING DOOR

(71) Applicant: Bishop-Wisecarver Corporation, Pittsburg, CA (US)

(72) Inventors: Andrew Jung, San Marcos, CA (US); Spencer Schaffer, Bakersfield, CA (US); Ngoan Nguyen, Pittsburg, CA (US)

(21) Appl. No.: 19/195,726

(22) Filed: Apr. 30, 2025

(51) Int. Cl. E06B 3/90; E05D 15/02; E05F 5/06

(52) U.S. Cl. CPC E06B 3/90; E05D 15/02; E05F 5/06; E05Y 2201/628; E05Y 2600/314; E05Y 2600/626; E05Y 2800/356; E05Y 2800/372; E05Y 2900/531

(57) ABSTRACT

Top and bottom sliding pivoting door mechanisms each include wheels for engagement with guide rails mounting in the top and bottom of a door opening enclosure. In each mechanism a support block is pivotably mounted to the wheels and one side of a connector plate is attached to the top or to the bottom of a door opening frame and the other side is connected to the support block by one or more bolts. The door frame is thus pivotable with respect to the door opening enclosure. The distance between the connector frame and the support block in each of the top and bottom mechanisms can be adjusted by tightening or loosening the bolts which in turn adjusts the distance between the wheels relative to the distance between the guide rails to minimize binding and play of the pivoting door as it slides within the door opening.

### BACKGROUND

### Technical Field

The present invention relates generally to mechanisms that allow doors mounting in a door opening enclosure to pivot and slide within the enclosure such as between open and closed positions and in particular to mechanisms to limit pivoting motion of such doors. CPC EO5D

### Description of Related Art

Mechanisms that allow doors to pivot and slide in a door enclosure are designed to provide both functionality and aesthetic appeal. Pivot doors operate on a central axis, typically mounted at the top and bottom of the door, that allows the door to rotate smoothly around a fixed point, enabling it to swing open in both directions. The pivot point is usually located at the center of gravity of the door, ensuring balanced movement and stability. This design is particularly useful in high-traffic areas, as it provides a wide clearance for people and objects to pass through.

Sliding doors, on the other hand, operate by moving along a track system installed either at the top, bottom, or both. Sliding doors are commonly equipped with rollers or gliders that facilitate smooth horizontal movement. Sliding doors are ideal for spaces where traditional swinging doors might be impractical due to space constraints and are often designed to slide into a wall cavity (e.g., pocket doors) or along the exterior of the wall.

Combining pivot and sliding mechanisms into a single door system can offer enhanced flexibility and space-saving benefits, making them suitable for both residential and commercial applications. However, there is no mechanism in the prior art to limit the pivoting door from over-rotating past an open position, which is generally parallel with a door opening enclosure, and a closed position, generally perpendicular to a door opening enclosure.

### SUMMARY OF THE INVENTION

A sliding pivoting door mechanism solves this problem by providing cooperating elements on both the pivot shaft and the bearing support that limit rotational movement of the door beyond a closed position that is parallel with a door opening enclosure in one direction and an open position in an opposite direction in which the door is disposed approximately perpendicular to the door opening enclosure.

Each pivoting sliding door mechanism comprises a pivot shaft, one end of which is connected to the guide wheels and the other end of which is connected to a bearing which is captured in a bearing support block. The bearing support is thus pivotably connected to the pivot shaft. The bearing is connected to the door frame so that it is pivotable with respect to the door opening enclosure.

The pivot shaft is pivotably received in an opening in the bearing support. According to the invention, engagement bars extend outwardly from the pivot shaft and stop blocks protrude inwardly from the wall of the opening. As the door pivots between open and closed positions, the bearing support pivots with it. In one direction the engagement bars of the pivot shaft meet with the stop blocks of the bearing to limit movement to a first position; in an opposition direction the engagement bars and stop blocks limit movement to a second position which may be approximately perpendicular to the first position. The locations of the engagement bars and stop blocks can thus be established so that the first position can put the door in a closed position and the second position can put the door in an open position perpendicular to the door opening enclosure.

### BRIEF DESCRIPTION OF THE DRAWINGS

FIG. 1 is a top perspective view of a door frame mounting in a door opening enclosure using top and bottom pivoting sliding door mechanisms.

FIG. 2 is a top perspective view similar to FIG. 1 showing the door frame pivoted to an open position roughly perpendicular to the door opening enclosure.

FIG. 3 is a top plan view showing the door while pivoted to an open position sliding within the door opening enclosure.

FIG. 4 is a top perspective view of a top sliding door mechanism for a pivoting sliding door showing a pivot-limiting mechanism according to the invention.

FIG. 5 is an elevational view thereof.

FIG. 6 is an exploded view thereof.

FIG. 7 is a bottom perspective view of a bottom sliding door mechanism for a pivoting sliding door showing the pivot-limiting mechanism according to the invention.

FIG. 8 is an elevational view thereof.

FIG. 9 is an exploded view thereof.

FIG. 10 is a top perspective view showing isolated elements of top and bottom pivot-limiting mechanisms in a first position according to the invention.

FIG. 11 is a top perspective view similar to FIG. 10 showing the elements in a second position.

FIG. 12 is bottom perspective view showing isolated elements of top and bottom pivot-limiting mechanisms in a first position according to the invention.

FIG. 13 is bottom perspective view similar to FIG. 12 showing the elements in a second position.

FIG. 14 is a top plan view of top pivot-limiting mechanism showing the elements in a first position.

FIG. 15 is an elevational view similar to FIG. 14 showing the elements in a second position.

### DETAILED DESCRIPTION OF THE ILLUSTRATED EMBODIMENT

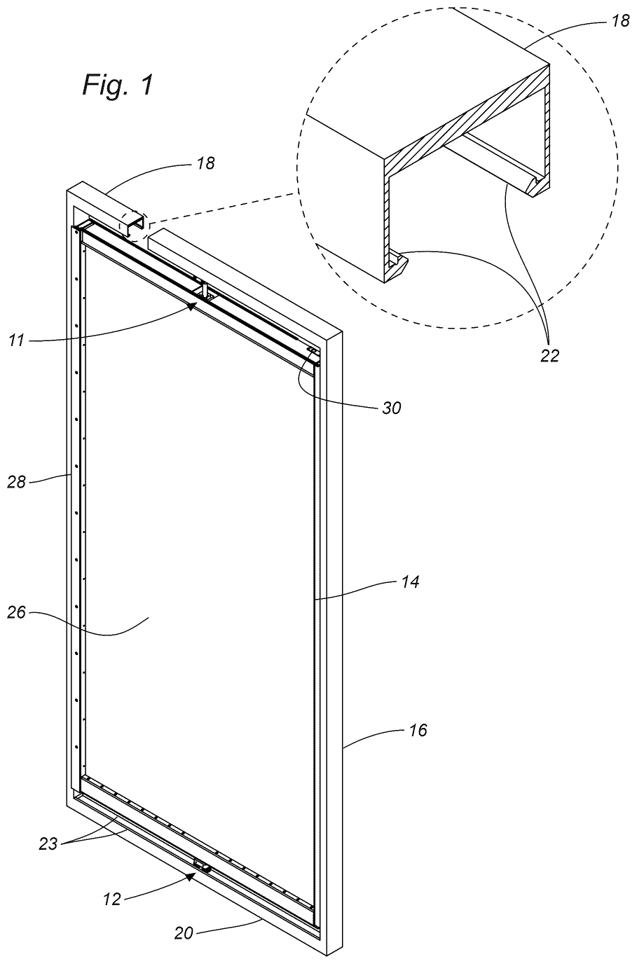

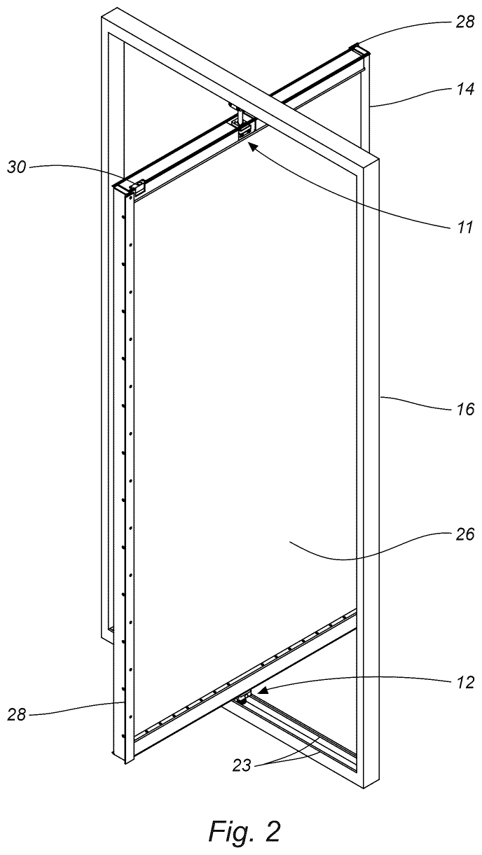

A pivot-limiting mechanism for a pivoting sliding door is now described with respect to the drawing figures. A pivot-limiting mechanism will generally comprise part of a pair of top and bottom sliding door mechanisms, such as top and bottom sliding door mechanisms 11, 12, seen in FIG. 1, that allow a door frame 14 to pivot within a door opening enclosure 16. For example, door frame 14 is shown in a closed position with respect to door opening enclosure 16 in FIG. 1 and in an open position in FIG. 2.

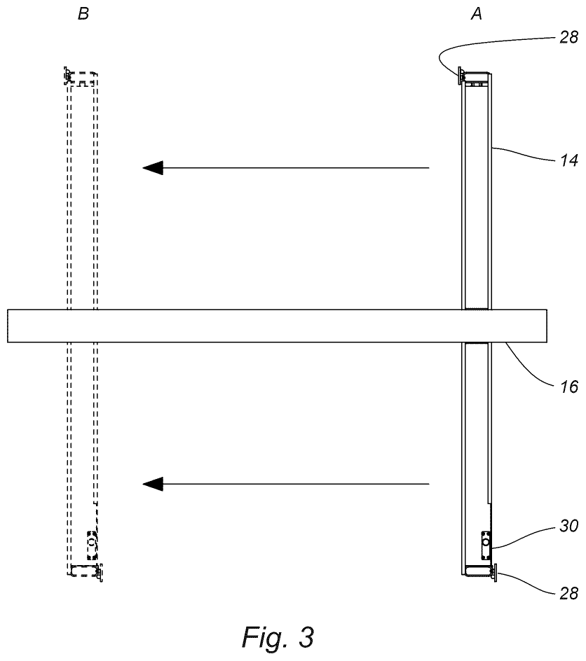

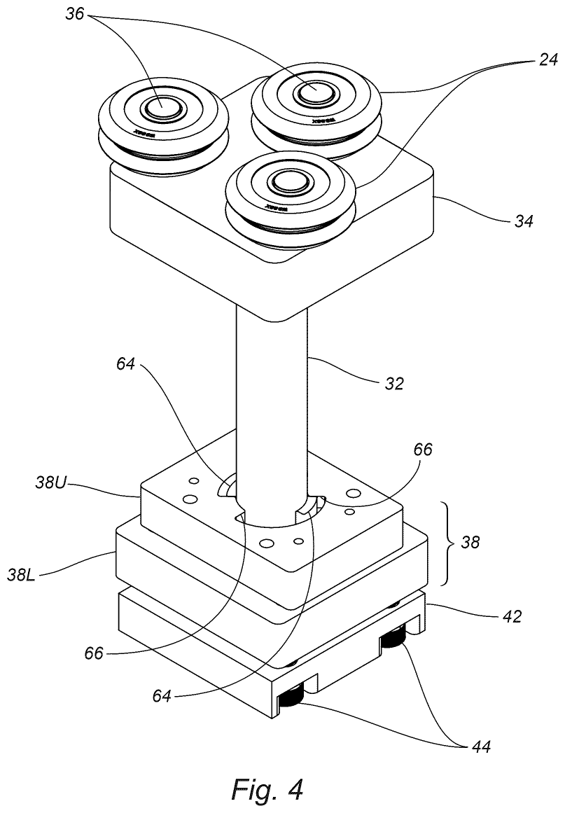

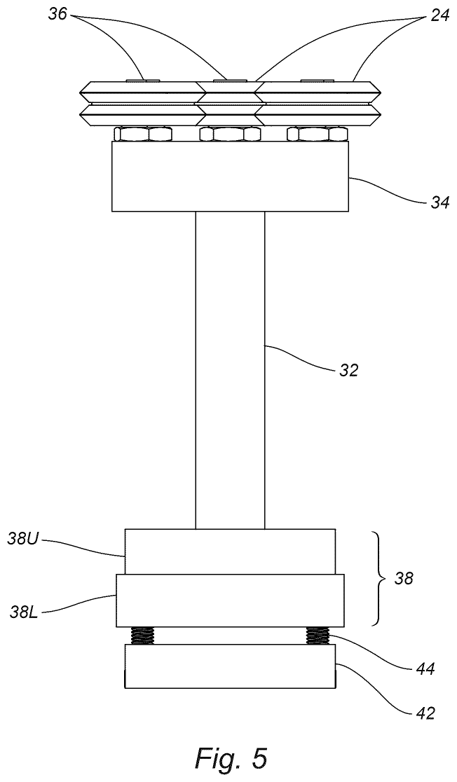

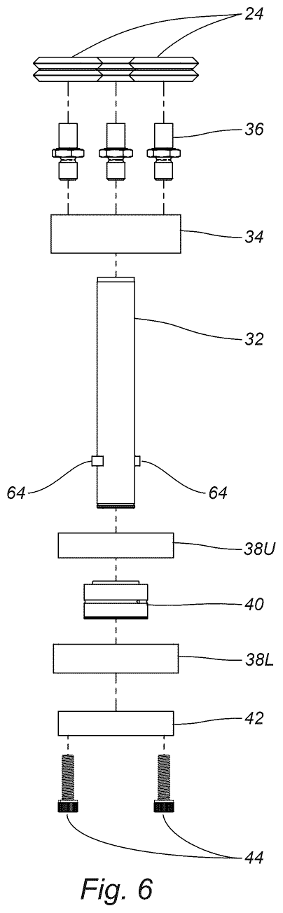

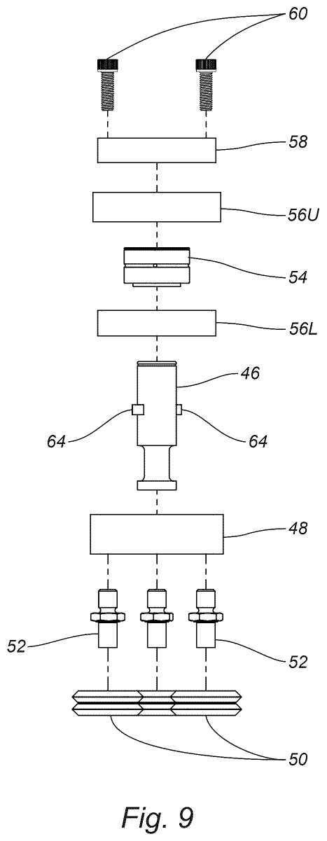

In addition to pivoting within the door opening enclosure 16, the door frame 14 can slide from a first position A within the enclosure to a second position B as seen in FIG. 3. The top 18 and bottom 20 of the door opening enclosure have top and bottom guide rails 22, 23 (see FIG. 1) which engage the wheels 24 (see FIGS. 4-9) of sliding door mechanisms 11, 12 thereby enabling the door frame 14 to pivot and slide within the door opening enclosure 16 as seen. In one embodiment, the guide rails 22, 23 have a V-shaped profile to best engage the dual V-shaped wheels 36 seen in FIGS. 4-9. Suitable dual V-shaped wheels are DualVee® guide wheels available from Bishop-Wisecarver Corporation. Suitable cooperating V-shaped guide track are UtiliTrak® or DualVee® Single Edge Track also available from Bishop-Wisecarver Corporation. In other embodiments, the door frame may encase one or more sheets of glass 26, may have side flanges 28 that overlap the door opening enclosure 16 when the door frame 14 is in the closed position as seen in FIG. 1, and may have a lock-receiving plate 30 for receiving the locking shaft of a lock (neither illustrated) mounted in the door opening enclosure 16. In another embodiment, the lock may be magnetically activated.

With reference now to FIGS. 4-6, a top pivoting sliding door mechanism 11 includes a top pivot shaft 32, the upper end of which is attached to a top wheel plate 34. Top wheels 24 are rotatably connected to the top wheel plate 34 via top wheel shafts 36 for rolling engagement with top guide rails 22 as mentioned above. The lower end of pivot shaft 32 is engaged with bearing 40 to pivotably connect the pivot shaft 32 with top bearing support 38. Top bearing support 38 comprises interconnected upper top bearing support 38U and lower top bearing support 38L between which is cooperatively captured bearing 40. Top bearing support 38 is adjustably attached to top connector plate 42 by top bolts 44. In the illustrated embodiment, top bearing support 38 is attached to top connector plate 42 by four bolts, but in other embodiments one to three or more than four bolts could be used.

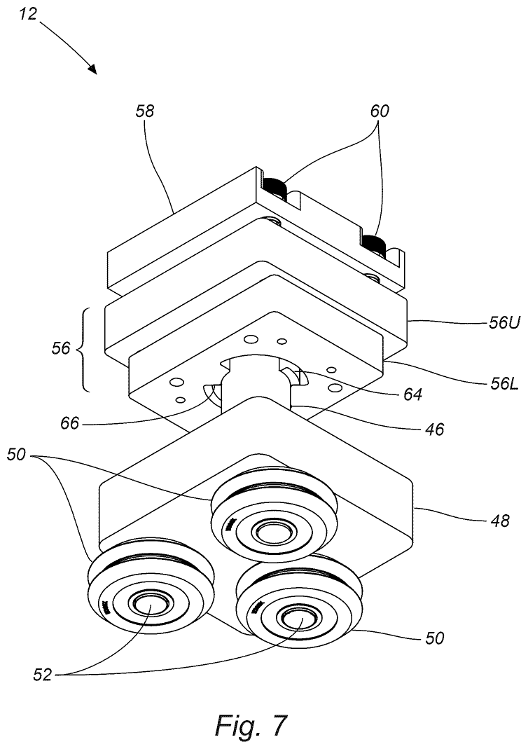

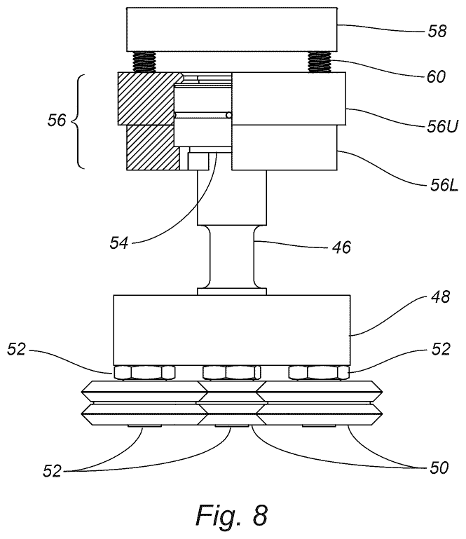

As seen in FIGS. 7-9, a bottom pivoting sliding door mechanism 12 includes a bottom pivot shaft 46, the lower end of which is connected to a bottom wheel plate 48. Bottom wheels 50 are rotatably connected to the bottom wheel plate 48 via bottom wheel shafts 52 for rolling engagement with the bottom guide rails 23 as discussed above. The upper end of the bottom pivot shaft 46 is engaged with bottom bearing 54 which is captured between upper bottom bearing support 56U and lower bottom bearing support 56L (see FIG. 8) which cooperatively interconnect to form bottom bearing support 56. The bottom pivot shaft 46 is thereby pivotably connected with bottom bearing support 56. Similarly to the top pivoting sliding door mechanism 10 discussed above, the bottom bearing support 56 is adjustably attached to bottom connector plate 58 by four bottom bolts 60 in the illustrated embodiment. However, in other embodiments one to three or more than four bolts could be used.

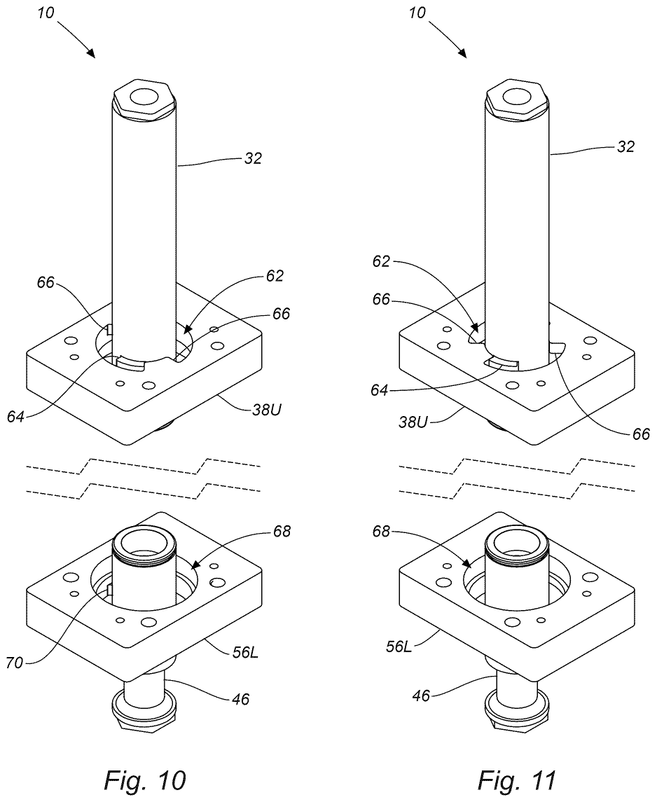

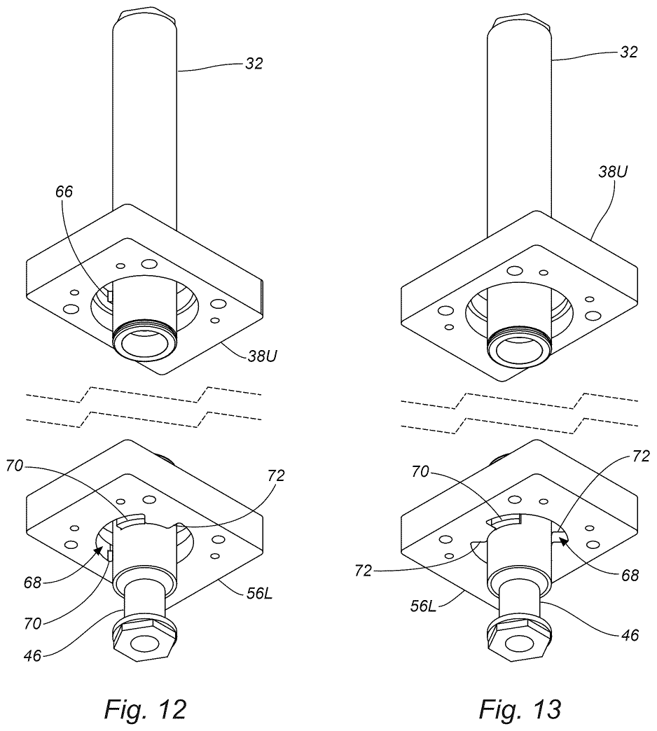

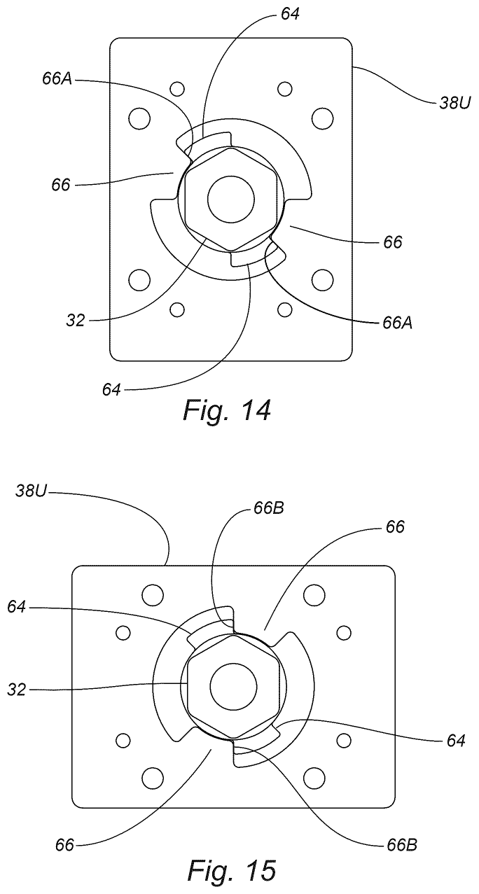

Isolated views of the top and bottom pivot shafts 32, 46 and the upper top and lower bottom bearings 38U and 56L are provided in FIGS. 10-15 to clarify the pivot-limiting mechanism 10. As shown, top pivot shaft 32 is rotatably received in central aperture 62 of upper top bearing support 38U. Top engagement bars 64 extend outwardly from pivot shaft 32 into central aperture 62. Conversely, top stop blocks 66 project inwardly from the inner surface of central aperture 62 for engagement with top engagement bars 64. In the upper parts of FIGS. 10 and 12 and FIG. 14 upper top bearing support 38U is shown rotated clockwise to a first position in which further rotation is limited by engagement of a first side edge 66A of top engagement bars 64 and top stop blocks 66. In FIGS. 11, 13 and 15 upper top bearing support 38U is shown rotated counterclockwise to a second position in which further rotation is limited by engagement of a second side edge 66B of top engagement bars 64 and top stop blocks 66. It will be understood that, depending on how top bearing support 38 is attached to a door frame, the first position could be consistent with the door being open in the door enclosure and the second position could be consistent with the door being closed.

Similarly, with respect to the bottom parts of FIGS. 10-13 and FIG. 15, bottom pivot shaft 46 is rotatably received in bottom aperture 68 of lower bottom bearing support 56L. Bottom engagement bars 70 extend outwardly from the pivot shaft 46 and bottom stop blocks 72 project inwardly from the inner surface of aperture 68 for engagement with bottom engagement bars 70. Corresponding to movement of the upper top bearing support 38U, in FIG. 10 it is seen that lower bottom bearing support 56L is shown rotated counterclockwise to a first position in which further rotation is limited by engagement of bottom engagement bars 70 with bottom stop blocks 72. FIG. 11 shows lower bottom bearing support 56L rotated clockwise to a second position in which further rotation is limited by engagement of bottom engagement bars 70 and bottom stop blocks 72. It is anticipated that top and bottom pivot mechanisms will be installed on the top and on the bottom of a pivoting door installed in a door opening enclosure such that they will work in tandem as described above. Thus, when the bottom bearing support 56 is in the first position, the door may be open and when the bottom bearing support 56 is in the second position, the door may be closed.

Pivot-limiting mechanisms for a sliding pivoting door are advantageous over prior art pivoting sliding door mechanisms since pivoting doors equipped with such pivot-limiting mechanisms can be easily moved to either open or closed positions by rotating the door in a selected direction until further movement is restricted.

There have thus been described and illustrated certain embodiments of a pivot-limiting mechanism for a sliding pivoting door according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

What is claimed is:

1. A pivot limiting sliding door mechanism comprising:
one or more bearing supports, one of said one or more bearing supports having an opening and one or more inwardly protruding stop blocks,
one or more pivot shafts, one of said one or more pivot shafts rotatably received in said opening, said pivot shaft having one or more outwardly extending engagement bars,
said pivot shaft rotatably movable in said bearing support between first and second positions, in said first position said engagement bars abutting said stop blocks thereby preventing further rotation of said pivot shaft in one direction, and in said second position said engagement bars abutting said stop blocks thereby preventing further rotation of said pivot shaft in an opposite direction.

2. The pivot limiting sliding door mechanism of claim 1 further comprising:
a bearing captured in said bearing support, and
said pivot shaft received in said bearing.

3. The pivot limiting sliding door mechanism of claim 2 further comprising:
a door opening enclosure,
a door frame,
said pivot shaft connected to said door opening enclosure, and
said bearing support connected to said door frame,
in said first position said door frame disposed parallel with said door opening enclosure in a closed position,
in said second position said door frame disposed perpendicularly to said door opening enclosure in an open position,
said that rotation of said pivot shaft between said first and second positions moves said door frame between closed and open positions relative to said door opening enclosure.

4. The pivot limiting sliding door mechanism of claim 3 further comprising:
said door opening enclosure having one or more guide rails,
one or more wheels engaged with said one or more guide rails, said one or more wheels connected to one of said one or more pivot shafts,
whereby said door frame can slide within said door opening enclosure along said guide rails.

5. The pivot limiting sliding door mechanism of claim 4 further comprising:
said door opening enclosure having a top and a bottom,
said one or more bearing supports including top and bottom bearing supports,
said one or more pivot shafts including top and bottom pivot shafts, said top pivot shaft received in the opening of said top bearing support, said bottom pivot shaft received in the opening of said bottom bearing support,
said top pivot shaft connected to the top of said door opening enclosure and said bottom pivot shaft connected to the bottom of said door opening enclosure.

6. The pivot limiting sliding door mechanism of claim 5 further comprising:
said one or more guide rails comprising one or more top guide rails and one or more bottom guide rails,
said one or more top guide rails affixed to the top of said door opening enclosure,
said one or more bottom guide rails affixed to the bottom of said door opening enclosure,
said one or more wheels comprising one or more top wheels and one or more bottom wheels, said one or more top wheels engaged with said one or more top guide rails, and said one or more bottom wheels engaged with said one or more bottom guide rails.

7. The pivot limiting sliding door mechanism of claim 1 wherein said one or more stop blocks comprises two or more stop blocks including first and second stop blocks disposed on opposite sides of said bearing support, and
said one or more engagement bars comprises two or more engagement bars including first and second engagement bars disposed on opposite sides of said pivot shaft.

8. The pivot limiting sliding door mechanism of claim 7 further comprising:
each of said first and second engagement bars having a first side edge and a second side edge, and
when said pivot shaft is in said first position, the first side edge of each of said first and second engagement bars abutting one of said first and second stop blocks, and
when said pivot shaft is in said second position, the second side edge of each of said first and second engagement bars abutting one of said first and second stop blocks.

9. The pivot limiting sliding door mechanism of claim 8 wherein said door in said first position disposed approximately perpendicularly to the disposition of said door in said second position.

10. A pivoting sliding door mechanism comprising:
one or more bearing supports, one of said one or more bearing supports having an opening and one or more inwardly protruding stop blocks,
a bearing captured in said opening, said bearing having an aperture,
one or more pivot shafts, one of said one or more pivot shafts received in said aperture so that it is rotatable in said bearing support, said pivot shaft having one or more outwardly extending engagement bars,
a door opening enclosure,
a door frame,
said pivot shaft connected to said door opening enclosure, and
said bearing support connected to said door frame,
said pivot shaft rotatably movable in said bearing support between first and second positions, in said first position said engagement bars abutting said stop blocks thereby preventing further rotation of said pivot shaft in a first direction and said door frame disposed parallel with said door opening enclosure in a closed position, and in said second position said engagement bars abutting said stop blocks thereby preventing further rotation of said pivot shaft in an opposite direction and said door frame disposed approximately perpendicularly to said door opening enclosure in an open position,
said that rotation of said pivot shaft between said first and second positions moves said door frame between closed and open positions relative to said door opening enclosure.

11. A pivoting sliding door mechanism comprising:
two or more bearing supports including top and bottom bearing supports, each of said top and bottom bearing supports having an opening and one or more inwardly protruding stop blocks,
two or more bearings including top and bottom bearings, said top bearing captured in the opening of said top bearing support, said bottom bearing captured in the opening of said bottom bearing support, each of said top and bottom bearings having an aperture,
two or more pivot shafts including top and bottom pivot shafts, said top pivot shaft received in the aperture of said top bearing of so that it is rotatable in said top bearing support, said bottom pivot shaft received in the aperture of said bottom bearing so that it is rotatable in said bottom bearing support, each of said top and bottom pivot shafts having one or more outwardly extending engagement bars,
a door opening enclosure having a top and a bottom,
a door frame,
said top pivot shaft connected to the top of said door opening enclosure, said bottom pivot shaft connected to the bottom of said door opening enclosure, and
said top and bottom bearing supports connected to said door frame,
said top and bottom pivot shafts rotatably movable in said top and bottom bearing supports between first and second positions, in said first position said engagement bars abutting said stop blocks thereby preventing further rotation of said pivot shafts in a first direction and said door frame disposed parallel with said door opening enclosure in a closed position, and in said second position said engagement bars abutting said stop blocks thereby preventing further rotation of said pivot shaft in an opposite direction and said door frame disposed approximately perpendicularly to said door opening enclosure in an open position,
said that rotation of said top and bottom pivot shafts between said first and second positions moves said door frame between closed and open positions set by said stop blocks and said engagement bars relative to said door opening enclosure.
